(19) United States
(12) Patent Application Publication
(10) Pub. No.: US 2021/0295627 A1
(43) Pub. Date: Sep. 23, 2021

(54) Face Based Door Entry and Confirmation of Authenticity of Biological Sample

(71) Applicant: POPID, INC., Diamond Bar, CA (US)

(72) Inventors: John Miller, Santa Monica, CA (US); Sean Olson, Diamond Bar, CA (US)

(21) Appl. No.: 17/331,611

(22) Filed: May 26, 2021

Related U.S. Application Data
(63) Continuation of application No. 16/879,097, filed on May 20, 2020.
(60) Provisional application No. 63/030,008, filed on May 26, 2020.
(60) Provisional application No. 62/850,301, filed on May 20, 2019.

(51) Int. Cl. G07C 9/25; G07C 9/27; G06K 9/00; H04L 9/32; G06Q 20/20; G06Q 10/02; G06T 7/73

(52) U.S. Cl. CPC G07C 9/257; G07C 9/27; G06K 9/00295; G06K 9/00335; G06K 9/00885; H04L 9/3271; G06T 2207/10048; G06Q 10/02; G06T 7/74; G06T 2207/30201; G06K 2009/00939; G06T 2200/24; G06Q 20/208

(57) ABSTRACT

In some embodiments, a method for confirming that a biological sample provided by an individual and sent to a testing facility was obtained from the individual includes obtaining a sample collection unit containing the biological sample and a video of the individual providing the biological sample. The individual provides the biological sample by recording a video of himself or herself: opening the sample collection unit; depositing the biological sample into the sample collection unit; and closing the sample collection unit. The method further includes analyzing the biological sample for one or more of at least one pathogen and at least one antibody to a pathogen; analyzing the video to ensure that the individual in the video provided the sample; and performing facial recognition on the video to correlate the sample collection unit and the biological sample to the individual.

### CROSS-REFERENCE TO RELATED APPLICATIONS

This application claims the benefit of U.S. patent application Ser. No. 16/879,097, filed May 20, 2020 and entitled FACE BASED DOOR ENTRY, which claims the benefit of U.S. Provisional Application No. 62/850,301, filed May 20, 2019 and entitled FACE BASED DOOR ENTRY, the entirety of each of which is hereby incorporated by reference.

### BACKGROUND OF THE INVENTION

### Field of the Invention

This invention relates to the use of facial recognition technologies.

### Description of the Related Art

Digital door lock systems are being widely adopted in residential and commercial buildings. In commercial buildings, digital door locks are necessary to effectively manage hundreds of employees in a building. Today, the primary mechanism used for triggering the opening of digital door locks is a digital key card. For purposes of this invention, digital key cards include (but not are not limited to) proximity cards, swipe cards, fobs, magnetic cards, and RFID/NFC cards. Increasingly, companies such as HID, OpenPath, and Butterfly are offering mobile solutions, where the mobile device can communicate with a door controller (or the lock directly) through QR code, low energy Bluetooth or through the cloud. While the use of mobile devices for entry eliminates the need for key cards that can be lost, stolen, or damaged, mobile devices present other issues. A user must be carrying the device; the device must have power; and it many cases, the user is required to interact with the device in some way before entering the door. What is needed is a more frictionless mechanisms for digital door entry.

Screening systems for identifying individuals infected, or likely to be infected, with certain infectious diseases and restricting their access to buildings, portions of buildings, or other areas also are becoming increasingly desirable. Recent global outbreaks of infectious diseases, such as COVID-19, have given rise to systems capable of human body surface temperature scanning, as elevated body temperature is a symptom of some such diseases. Individuals found to have a body temperature above a particular threshold may be isolated for further evaluation or simply denied access to the building or area. However, body surface temperature scanning alone may be insufficient to identify individuals with infectious disease or who are likely to have such diseases. Moreover, although such systems may be useful for identifying individuals having elevated temperature from a crowd (e.g., at an airport or stadium), they lack features needed to evaluate and track the health status of particular individuals in a semi-automated or fully-automated manner. In addition, such systems lack features that provide touch-free, personalized functions (e.g., payment capabilities or instructions) to individuals admitted to a building or area, again in a semi-automated or fully-automated manner. What is needed are systems that better enable identification and tracking of individuals who are infected, or likely to be infected, with certain diseases and restrict their access to protected areas in a semi-automated or fully-automated manner. What is also needed are systems that better provide touch-free, personalized functions to individuals admitted to an area in a semi-automated or fully-automated manner.

Various embodiments of the several inventions disclosed herein address these, inter alia, issues.

### SUMMARY

It would be desirable to devise more frictionless systems for digital door entry that do not require the individual attempting to gain access to provide an object such as a proximity card, swipe card, fob, magnetic card, RFID/NFC card, or personal mobile device. It further would be desirable for some such systems for digital door entry to include features that enable accurate identification of individuals who are infected, or likely to be infected, with certain diseases and restriction of such individuals' access to protected areas. It further would be desirable for some such systems for digital door entry to include features that provide personalized functions to individuals admitted to an area, such as personalized payment functions or personalized instructions for receiving goods and/or services. In any such examples, it would be desirable for the systems to perform these functions in a semi-automated or fully-automated manner that may be touch-free for the individual attempting to gain access to an area and/or utilize other personalized functions.

To this end, systems and methods for digital door entry that rely on facial recognition technology instead of requiring an individual to provide an object such as a proximity card, swipe card, fob, magnetic card, RFID/NFC card, or personal mobile device, are described herein. The systems and methods described herein may include one or more features that enable accurate identification of individuals who are infected, or likely to be infected, with certain diseases and restriction of such individuals' access to protected areas. Additionally, or alternatively, the systems and methods described herein may include one or more features that provide personalized functions to individuals admitted to an area, such as personalized payment functions or personalized instructions for receiving goods and/or services. Any of the systems and methods described herein may function in a semi-automated or fully-automated manner that is touch-free for the individual attempting to gain access to an area and/or utilize other personalized functions.

An embodiment is a system for regulating a digital door lock based on facial recognition of an individual, the system comprising: a housing containing: a graphical user interface; an optical camera; a temperature sensor configured to receive infrared radiation from the individual when the individual is positioned within a sensing zone the temperature sensor; communication circuitry; and processing circuitry configured to: control the graphical user interface to display one or more questions and one or more corresponding answers for the individual to select; receive a signal from the graphical user interface corresponding to the individual's answers to the one or more questions, receive a signal corresponding to an image of the face of the individual captured by the optical camera when the individual is positioned in a sensing zone of the camera; determine an identity of the individual based on the image of the face; receive a signal corresponding to the infrared radiation from the individual sensed by the temperature sensor and determine a body temperature of the individual based on the signal; determine the health status of the individual based on the body temperature of the individual and the individual's responses to the one or more questions; and determine whether or not to cause the communication circuitry to transmit a signal to the digital door lock instructing the digital door lock to unlock based on the identity and the health status of the individual.

A further embodiment is a system for regulating a digital door lock based on facial recognition of an individual and a reserved access time associated with the individual, the system comprising: a apparatus comprising: a housing containing: an optical camera; communication circuitry; and processing circuitry configured to: receive a signal corresponding to an image of the face of the individual captured by the optical camera when the individual is positioned in a sensing zone of the optical camera; determine an identity of the individual based on the image of the face; based on the identity of the individual and the current time, determine whether the individual has a valid reservation to access an area secured by the digital door lock at the current time; and cause the communication circuitry to transmit a signal to the digital door lock instructing the digital door lock to unlock based on a determination that the individual has a valid reservation to access the area secured by the digital door lock at the current time.

A further embodiment is a system for regulating guest check-in at an establishment based on facial recognition of an individual, the system comprising: a apparatus comprising: a housing containing: a graphical user interface an optical camera; and processing circuitry configured to: receive a signal corresponding to an image of the face of the individual captured by the optical camera when the individual is positioned in a sensing zone of the optical camera; determine an identity of the individual based on the image of the face; determine, based on the identity of the individual and the current time, whether the individual has a valid reservation to access reserved goods or services at the establishment at the current time; and cause the graphical user interface to display instructions for the individual to access the reserved goods or services based on a determination that the individual has a valid reservation.

The description of the invention and its applications as set forth herein is illustrative and is not intended to limit the scope of the invention. Features of various embodiments may be combined with other embodiments within the contemplation of this invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

### DETAILED DESCRIPTION OF THE DRAWINGS

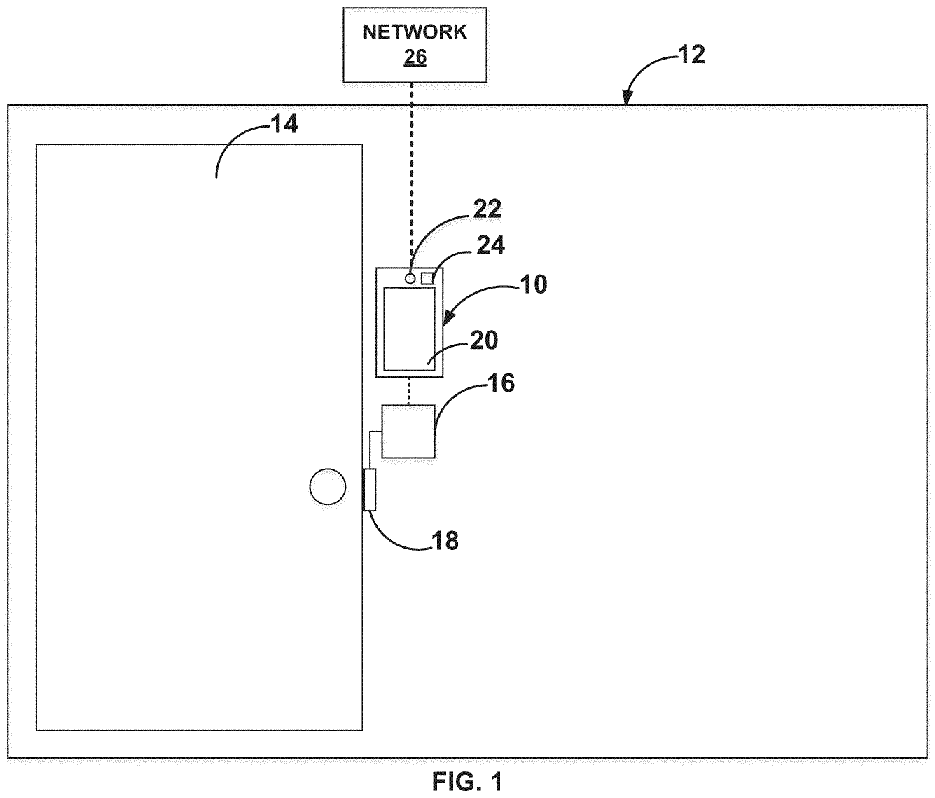

FIG. 1 is a conceptual drawing illustrating an example configuration of a face-based door entry system according to one or more embodiments.

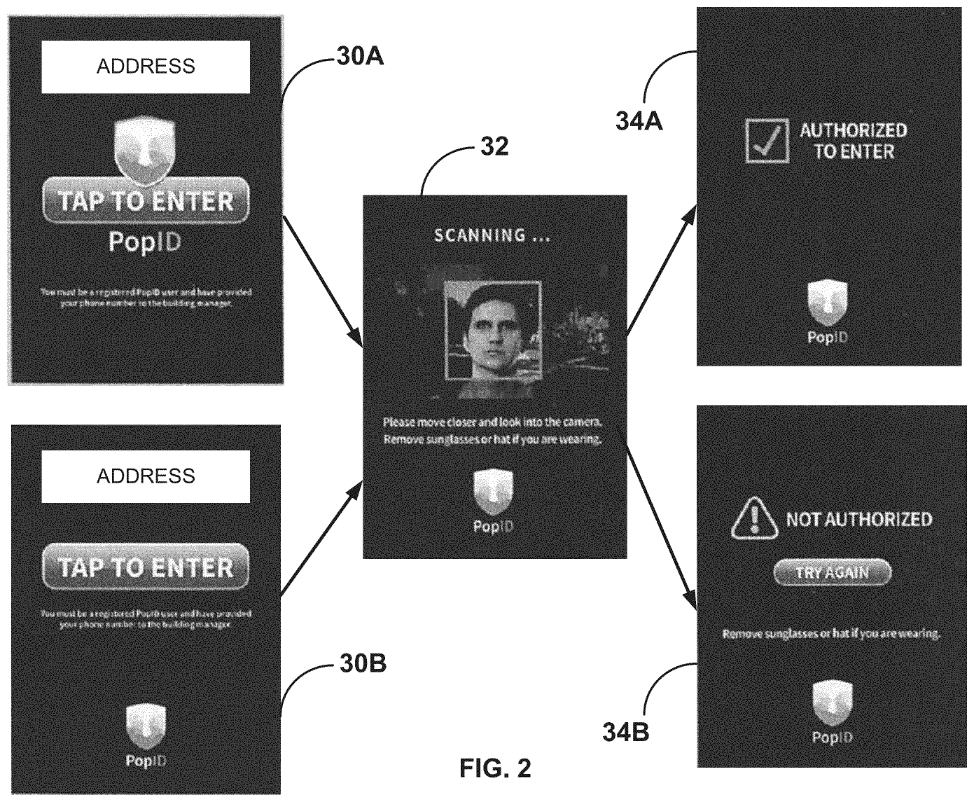

FIG. 2 is a conceptual drawing illustrating an example user interface of the apparatus of FIG. 1 during a face-based door entry process.

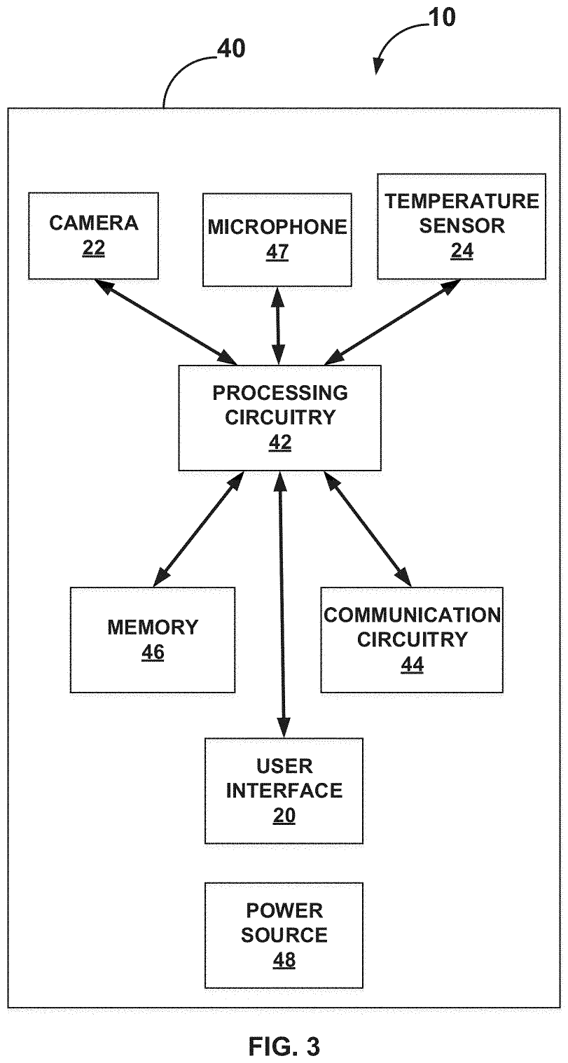

FIG. 3 is a functional block diagram of an example configuration of the face-based door entry system of FIG. 1 according to one or more embodiments.

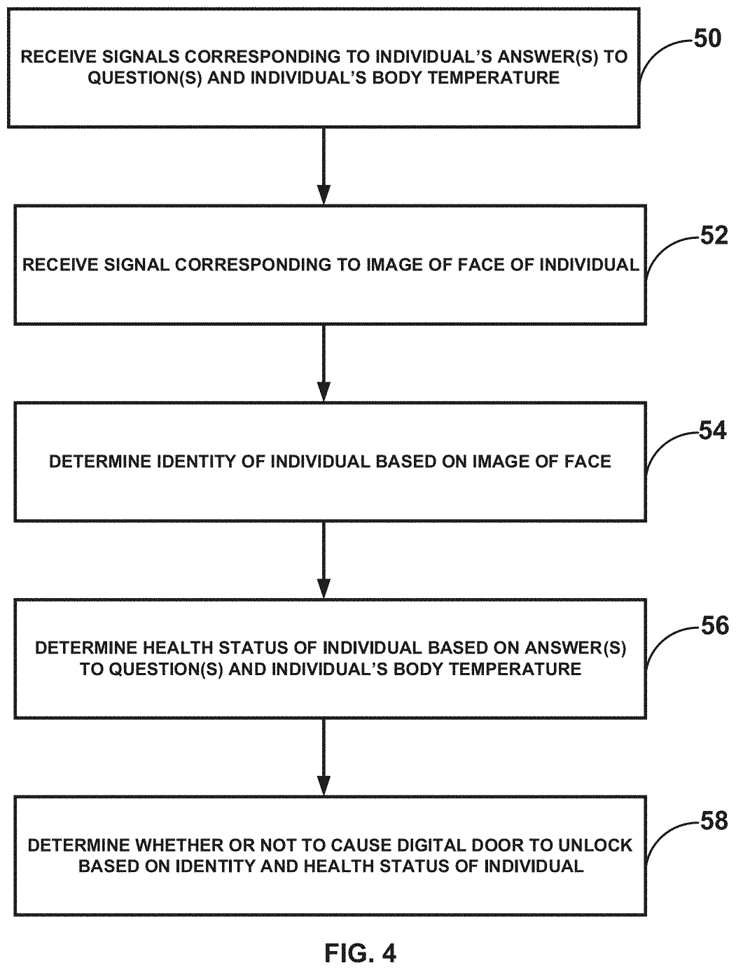

FIG. 4 is a flow diagram of an example technique for using a face-based door entry system according to one or more embodiments.

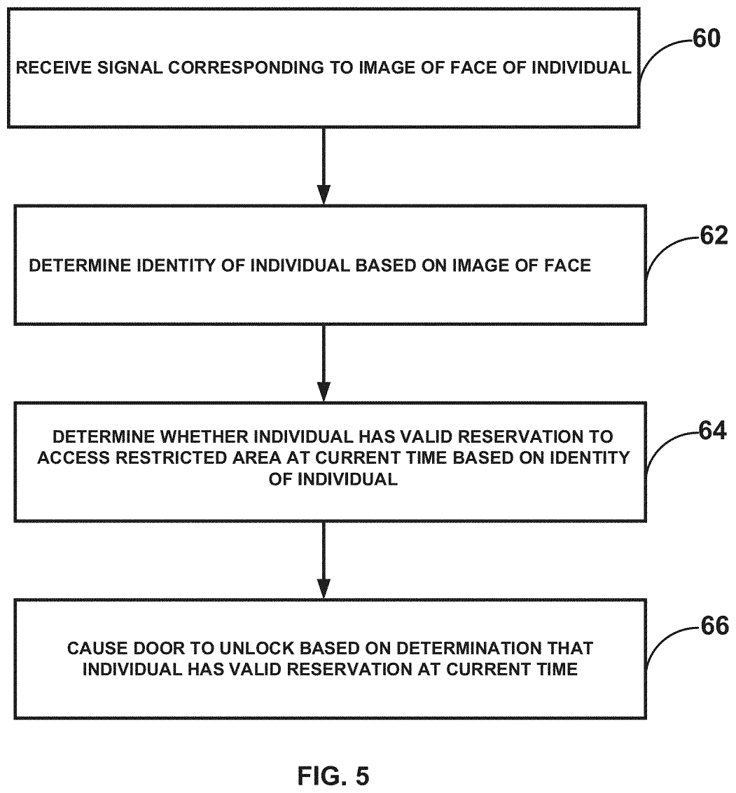

FIG. 5 is a flow diagram of another example technique for using a face-based door entry system according to one or more embodiments.

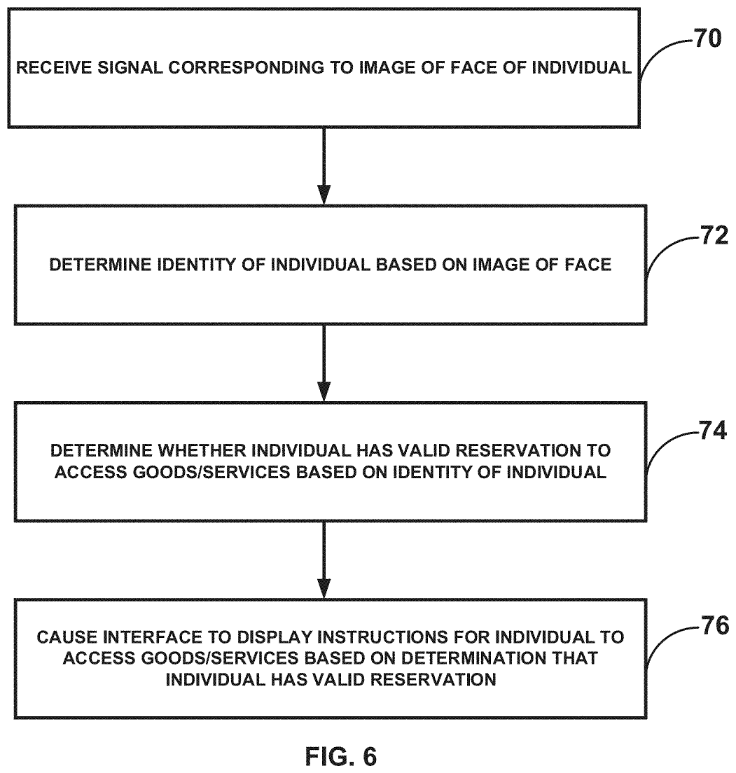

FIG. 6 is a flow diagram of an example technique for using a face-based guest check-in system according to one or more embodiments.

### DETAILED DESCRIPTION OF THE INVENTION

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

Facial recognition technology has become increasingly accurate and fast. PopID, for example, is a two-sided marketplace that allows merchants to authenticate customers in retail transactions at the point of sale. Consumers register for PopID and can then use the service to pull up loyalty accounts and make payments using a camera to scan the consumer's face. The present invention is related to use of facial recognition to authenticate an individual seeking to enter through a digitally-controlled door, make payments, and/or access reserved goods or services.

FIG. 1 is a conceptual drawing illustrating an example configuration of a face-based entry system 10, according to one or more embodiments, positioned within an environment 12. In addition to entry system 10, the environment 12 comprises a door 14, a door access panel controller 16 communicatively coupled to the entry system 10, and a door striker 18 communicatively coupled to and controlled by the door access panel controller 16. The door access panel controller 16 and the door striker 18 collectively comprise a digital door lock. The door access panel controller 16 and the entry system 10 may be connected through Rex input or the door access panel controller 16 and/or door striker 18 may be connected to the entry system 10 via wireless communication such as low-energy Bluetooth.

As discussed herein, the entry system 10 may be configured for operation in different environments in addition to or instead of environment 12. Thus, it should be understood that the entry system 10 may include one or more features described herein as being optional, as appropriate to the environment in which an embodiment of the entry system 10 is intended to operate. For example, although the entry system 10 is illustrated as being mounted to a wall adjacent the door 14 in FIG. 1, the entry system 10 may be positioned in any convenient location for use in the applications described herein, including in a kiosk or hand-held unit configured for operative communication with the digital door lock. Additionally, or alternatively, the entry system 10 may be configured to enable an individual to choose between use of a digital key card, fob, or other physical device and using facial recognition to gain access to an area regulated by the digital door lock and/or may be configured to allow use of a digital key card, fob, or other physical device as backup in case of camera or other malfunction.

In the embodiment illustrated in FIG. 1, the entry system 10 includes a graphical user interface 20, an optical camera 22, and an optional temperature sensor 24. The use of the optional temperature sensor 24 is further described with respect to FIGS. 3-5. The entry system 10 may be configured to wirelessly access a cloud or edge network 26 for transmitting and receiving data by any suitable known method. The graphical user interface 20 may comprise an electrophoretic display, an LED backlit LCD display, or other suitable display medium, which may be touch-responsive or non-touch responsive based on the application. Applications in which the graphical user interface 20 comprises an electrophoretic display desirable may reduce power consumption by the entry system 10 relative to other display media, enabling the entry system 10 to operate for a substantial period of time without being connected to an external power source. The optical camera 22 may be a standard IP camera, a three-dimensional (3D) camera, or another suitable type of camera, again based on the application and as further discussed below. In applications where a touch-responsive graphical user interface 20 is desired, an individual seeking to gain access to an area secured by the digital door lock can touch a button on the graphical user interface 20 to trigger the process of unlocking the digital door lock. In any such examples, an image of the individual's face may be uploaded to the network database when the individual creates a digital account with his or her picture (e.g., a PopID profile) that can be used with any embodiment of system 10 at any location.

In applications where a non-touch responsive graphical user interface 20 is desired; e.g., where it is desirable to reduce transmission of surface-borne pathogens (e.g., viruses or bacteria), the entry system 10 may be configured to trigger the process of unlocking the digital door lock when an individual seeking to gain access to an area secured by the digital door lock positions himself or herself within a sensing zone of the camera 22. In some such applications such as those in which the individual is required to answer one or more questions (e.g., pertaining to the health of the individual) presented on the graphical user interface 20 as part of the process of unlocking the digital door lock, the camera 22 may be a 3D camera configured to track eye gaze or other gestures of the individual and identify a selected answer among answer choices presented to the individual on the graphical user interface 20. Additionally, or alternatively, the entry system 10 in some such applications may include a microphone (shown in FIG. 3) for the individual to provide voice answers to the questions, which may be visually presented to the individual via the graphical user interface 20 or presented in audio form via a speaker contained within the entry system 10. In any such instances, the questions and/or answers presented to the individual may be pre-recorded or may be administered by a live person. In such examples, the individual may upload a record of their voice to the network database when the individual creates his or her digital account (e.g., the PopID profile) for use with any embodiment of system 10 at any location. The recorded sample of the individual's voice may help facilitate understanding of the individual's responses to the one or more questions.

FIG. 2 is a conceptual drawing illustrating an example display by the graphical user interface 20 of FIG. 1 during a face-based door entry process. Panels 30A and 30B illustrate two alternate welcome displays on the graphical user interface 20 that prompt an individual to trigger the process of unlocking the digital door lock. Various icons and other information such as branding, address information, and instructions for use may be positioned on the welcome display as desired. Although the graphical user interface 20 of the process illustrated in FIG. 2 is touch-responsive and prompts an individual to touch the screen to trigger the process at 30A or 30B, the process illustrated in FIG. 2 may be triggered by a motion sensor of the entry system 10 detecting motion of the individual approaching the entry system 10. Additionally, or alternatively, the process may be activated by the camera 22 recognizing one or more particular physical gestures by the individual, such as a nod or standing still. Regardless of the manner in which the process of unlocking the digital door lock is triggered, the entry system 10 includes processing circuitry configured to receive a signal corresponding to an image of the face of the individual captured by the camera 22 and determine an identity of the individual based on the image of his or her face.

As shown in panel 32 of FIG. 2, the graphical user interface 20 may provide instructions to the individual for properly positioning himself or herself in front of the camera 22 and/or instruct the individual to remove accessories that may interfere with image capture. The graphical user interface 20 may display the image being obtained by the camera 22 to aid positioning of the individual. Additionally, or alternatively, a housing of the entry system 10 may be movable to enable the individual to adjust the angle of the camera 22 directly capture his or her face. Upon adjusting the angle of the camera 22, the individual can touch a button on the graphical user interface 20 to trigger the unlock process of the digital door lock. Alternatively, the entry system may be configured to automatically adjust the angle of the camera 22 to capture the individual's facial image and automatically proceed with the unlock process after the camera 22 has been adjusted.

In some applications, the processing circuitry may compare the image of the individual's face to a database of authorized entrants stored in a memory of the entry system 10. In some other applications, the processing circuitry may access a remote database via communication circuitry of the entry system 10 and the network 26 to enable comparison of the image of the individual's face to the remote database. If the comparison of the image of the individual's face to those in the database does not produce a match, the entry system 10 does not instruct the digital door lock to unlock. If a match for the individual's face is found, the entry system 10 determines the individual's identity and instructs the door access panel controller 16 to unlock the door striker 18 as shown at panel 34A. If no match for the individual's face is found, the entry system 10 determines that the individual is not authorized to gain entry and may display a message via the graphical user interface 20 indicating that access is denied and/or prompting the individual to re-attempt the process as shown at panel 34B. The process of FIG. 2 may be adapted to other applications as needed, such as for use in a digital door entry system that is further based on a health status of an individual and/or a reserved access time, as respectively discussed with respect to FIGS. 4 and 5, or in system for regulating guest check-in at an establishment as discussed with respect to FIG. 6.

FIG. 3 is a functional block diagram illustrating an example configuration of the face-based door entry system 10 of FIG. 1 according to one or more embodiments. In the illustrated example, the entry system 10 includes processing circuitry 42, communication circuitry 44, memory 46, optional microphone 47, and power source 48. The electronic components of entry system 10 may receive power from the power source 48, which may be a rechargeable or non-rechargeable battery (e.g., capable of delivering 12 vdc or 24 vdc). In other applications, the entry system 10 may be hard-wired to an external power source and the power source 48 may be optional. In other examples, the entry system 10 may include more or fewer electronic components.

The described circuitry may be implemented together on a common hardware component or separately as discrete but interoperable hardware or software components. Depiction of different features as circuitry is intended to highlight different functional aspects and does not necessarily imply that such circuitry must be realized by separate hardware or software components. Rather, functionality associated with one or more circuitry may be performed by separate hardware or software components, or integrated within common or separate hardware or software components.

Memory 46 includes computer-readable instructions that, when executed by processing circuitry 42, cause the entry system 10 and processing circuitry 42 to perform various functions attributed to the entry system 10 and processing circuitry 42 herein (e.g., receiving signals from other components, determining an identity, health status, and/or reservation status of an individual, and/or causing communication circuitry 44 to communicate with an external computing device). Memory 46 may include any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital or analog media.

Processing circuitry 42 may include any one or more of a microprocessor, a controller, a digital signal processor (DSP), an application specific integrated circuit (ASIC), a field-programmable gate array (FPGA), or equivalent discrete or analog logic circuitry. In some examples, processing circuitry 42 may include multiple components, such as any combination of one or more microprocessors, one or more controllers, one or more DSPs, one or more ASICs, or one or more FPGAs, as well as other discrete or integrated logic circuitry. The functions attributed to processing circuitry 42 herein may be embodied as software, firmware, hardware or any combination thereof.

FIGS. 4-6 are flow diagrams illustrating various techniques related to using a face-based door entry system to regulate access to restricted areas and/or reserved goods or services, in accordance with examples of this disclosure. As described herein, the techniques illustrated in FIGS. 4-6 may be accomplished using entry system 10, as described above with respect to FIGS. 1-3. Although described as being performed by entry system 10, the techniques of FIGS. 4-6 may be performed, in whole or in part, by processing circuitry and/or memory of other devices of a system configured to regulate access to restricted areas and/or reserved goods or services, as described herein. For example, although processing circuitry 42 of entry system 10 is described as carrying out most of the example techniques illustrated in FIGS. 4-6 for the sake of clarity, in other examples, one or more devices (e.g., a remote computer located with an external server) may carry out one or more steps attributed herein to the processing circuitry 42 of entry system 10.

FIG. 4 is a flow diagram of an example technique for using the face-based door entry system 10 that includes regulating a digital door lock based on facial recognition and health status of an individual. In general, the technique of FIG. 4 advantageously enables identification and tracking of individuals who are infected, or likely to be infected, with certain diseases and restrict their access to protected areas in a semi-automated or fully-automated manner via the entry system 10.

According to the embodiment of FIG. 4, processing circuitry 42 receives a signal from the graphical user interface 20 corresponding to an individual's answers to one or more questions presented to the individual via the graphical user interface 42, and further receives a signal corresponding to infrared radiation from the individual sensed by the temperature sensor 24 (50). The one or more questions may be related to the health of the individual, such as whether the individual is currently or has recently been experiencing symptoms associated with one or more particular infectious diseases, and/or whether the individual has recently been exposed to individual(s) experiencing such symptoms or diagnosed with such infectious disease(s). The processing circuitry 42 further receives a signal from the graphical user interface 20 corresponding to an image of the face of the individual captured by the optical camera 22 when the individual is positioned in a sensing zone of the camera 22 (52).

After receiving the signals corresponding to the infrared radiation, the individual's answers to the one or more questions, and the image of the face of the individual, the processing circuitry 42 of determines the identity of the individual based on the image of the face (54). As discussed above, the processing circuitry 42 may determine the identity of the individual by comparing the image of the individual's face to a database of authorized entrants stored in memory 46 of the entry system 10 in some embodiments. In other embodiments, the processing circuitry 42 may access a remote database via communication circuitry 44 of the entry system 10 and the network 26 to enable comparison of the image of the individual's face to images in the remote database. In either case, if the processing circuitry 42 finds a match for the image of the individual's face in the database, the processing circuitry 42 determines the identity of the individual as being the identity associated with the facial image in the database. If the processing circuitry 42 does not find a match for the image of the individual's face in the database, the processing circuitry 42 may identify/designate the identity of the individual as “unknown,” “unauthorized,” or the like, and the entry system 10 will not cause the digital door lock to unlock.

Next, the processing circuitry 42 determines the health status of the individual based on the body temperature of the individual and the individual's responses to the one or more questions (56). For example, with respect to the body temperature of the individual, the processing circuitry 42 may compare the determined body temperature value to a predetermined range of body temperature values and determine whether the individual has an elevated body temperature that may be a symptom of the one or more infectious diseases. The range of body temperature values may be generally applicable to humans past infancy or may be specific to the individual, if the individual is known to the database.

In instances in which the individual is known to the database (i.e., has a profile in the database, such as a PopID profile), the body temperature determined by the processing circuitry 42 may be stored in the individual's profile with an associated time/date stamp, along with the individual's facial image and/or voice information. In this manner a range of normal body temperatures specific to the individual may be established and/or a health status record of the individual may be maintained. A range of normal values for other physiological parameters, particularly those that may be affected by infectious disease, such as heart rate and/or respiratory rate, also may be established and stored in the database. For example, the camera 22 of the entry system 10 may be an RBG camera capable of detecting the individual's heart rate and/or respiratory rate. In such instances, the processing circuitry 42 may be configured to detect values of such other physiological parameters of the individual based on the signal received from the camera 22. Similarly, in instances in which the individual is known to the database, the individual's responses to the one or more questions may be stored in the individual's profile with an associated time/date stamp.

Additionally, or alternatively, immunity status of the individual to one or more infectious diseases may be stored in the individual's profile and may comprise part of the individual's health status as determined by the processing circuitry 42. For example, the individual's health profile may indicate whether the individual has been immunized against the disease(s) and/or has tested negative for the disease(s) within a preceding time period. In some embodiments, a laboratory that processes a biological sample from the individual to determine whether the individual is positive or negative for one or more types of disease-causing pathogens, such as viruses and/or bacteria, may securely upload the test results to a database where they are stored in the individual's profile (e.g., PopID profile).

In some instances in which the individual is known to the database (i.e., has a profile in the database, such as a PopID profile), the individual's profile may be used in a system of ensuring that a particular biological sample obtained by the individual (e.g., at the individual's home) and sent to a testing facility was indeed obtained from the particular individual. For example, the system may be used to verify that the individual has provided a biological sample by the individual taking a video of himself providing the sample and uploading the video to the database in addition to sending the sample to the testing facility. Such a system advantageously may reduce the administration cost of tests for immunity to and/or infection of the individual with one or more infectious diseases. For example, such a system may make it easier and cheaper for the individual to take a saliva-based test for antibodies to the SARS-CoV-2 virus that causes the disease COVID-19. Moreover, the result of such tests may be linked to the entry system 10, as further described below.

In some embodiments in which the system may be used to verify that the individual has provided a biological sample by the individual taking a video of himself providing the sample and uploading the video to the database, the individual may use a camera, such as a camera on a mobile phone, to record a video of an individual providing a biological sample into, such as spitting into, a sample collection unit for the subsequent test, where the test is a saliva-based test. The system likewise may be used with other types of tests, such as a nasal-swab test or others. One or more methods may be used to ensure that the individual in the video is the person who actually provided the saliva sample rather than a different individual. For example, facial recognition techniques, such as those described herein, may be used to verify the identity of the individual in the video. In another example, the individual may provide a picture or video footage of a photo ID, such as a driver's license or passport, to confirm his or her identity. In such examples, the video (including any additional video or pictures) may be analyzed to determine if it has been altered in any way. Such analysis of the video may be performed using algorithms commonly described as artificial intelligence, such as where at least one convolutional neural network is used to analyze the video.

In some embodiments in which the system may be used to verify that the individual has provided a biological sample by the individual taking a video of himself providing the sample and uploading the video to the database, the individual may use a sample collection unit comprising a vial with a screw on cap. In such examples, the video taken by the individual includes footage of the individual opening the container for the first time and then spitting into the sample collection unit. In such embodiments, the sample collection unit may include a compound that indicates that the sample collection unit has been opened for the first time via a visual indicator that can be recorded by the camera. By analyzing the video to confirm that the sample collection unit is being opened for the first time and then analyzing the video to confirm the individual spit into the sample collection unit, it is possible to increase the likelihood that the individual shown in the video spitting into the sample collection unit is the individual who provided the sample.

Various compounds and associated methods can be used to indicate when a sample collection unit has been opened for the first time, including chemicals that react with other chemicals or compounds that are present in the air, such as oxygen. Additionally, or alternatively, the sample collection unit may contain a chemical or chemicals that prevent a reaction among another chemical or chemicals in the sample collection unit. When the sample collection unit is opened, these reactions can proceed thereby providing the visual indicator. A sample visual indicator is a colorimetric oxygen indicator, such as a redox dye indicator an example of which is Ageless Eye, a product by Mitsubishi Gas Chemical Company.

In some embodiments, a sample collection unit contains a mechanism that provides an indicator of when the sample collection unit is closed. Such a mechanism may include a visual indicator that is activated when the sample collection unit is closed. Such an indicator may be accomplished in various ways. In one implementation, the sample collection unit includes a threaded top and cap. When the sample collection unit is closed, the twisting of the cap past a predefined point creates a visual indicator via the mechanical action of the twisting. In some embodiments, the sample collection unit cannot be reopened once it has been closed without damaging it or creating a visual indicator.

In some embodiments, a sample collection unit may be marked with an identifier that is visible to the camera. The identifier may be invisible to the individual but still visible to the camera. The identifier may be a unique identifier that can be captured on video and which is difficult to reproduce, such as certain types of holographic images, a QR code, a combination thereof, or the like.

In some embodiments, a sample collection unit may include a substance that visually indicates that it has come into contact with saliva. The use of such a system can help to confirm that the individual spitting into the sample collection unit is the person who is providing the sample. There are many options for visual indicators for saliva. For example, the enzyme α-amylase is found in very high levels in saliva and a range of products are able to use α-amylase as an indicator for the presence of saliva.

In some embodiments, a sample collection unit may be configured such that it enables or effectively enables one way flow of liquid, such as saliva, into the sample collection unit. In embodiments, a straw with a one way valve is one part of the apparatus used to collect the individual's saliva

In a method comprising some or all of the previously described embodiments, an individual wishing to demonstrate that he or she has specific antibodies (and hence, some level of resistance) to a specific illness may acquire a saliva-based test for such antibodies and wish to take the test in a way that ensures that he can prove that he is the person who provided the biological sample. Such a method alternatively may be used to test for a current infection status of the individual. In an example method of testing for antibodies, such a method may comprise the following steps, which may be performed in the following order or another suitable order:

(a) The individual sets up a cameras (such as the one on his mobile phone) and records a video of the following of himself performing the following actions:

(b) The individual opens the sample collection unit, which may provide a visual indicator that it has been opened for the first time and may contain a visual identifier so that it can be later identified and correlated to the individual when it is analyzed;

(c) The individual spits or otherwise deposits his or her saliva into the sample collection unit, which may provide a visual indicator to show the presence of saliva;

(d) The individual closes the sample collection unit, which may provide a visual indicator showing that it has been closed;

(e) Optionally, the individual may provide video or photo of a photo ID of the individual;

(f) The individual provides the sample collection unit and the video to one or more labs;

(g) The one or more labs analyze the sample for the presence of certain antibodies;

(h) The one or more labs analyze the video to ensure that the individual in the video provided the sample;

(i) The one or more labs perform facial recognition on the video to correlate the sample collection unit and provided sample to the individual;

(j) Optionally, the one or more labs correlate the identity of the individual to the provided image in the photo ID.

In some embodiments of such methods for antibody or infection testing, the steps of the sequence are shot such that the individual is always present in the video.

In any such embodiments, the results of the sample are connected to the individuals face and the individual's face is then used at a facial recognition enabled entry system to provide access to those with desired sample test results.

In other embodiments, the individual may have access to testing equipment that enables him or her to test himself or herself for the one or more disease(s) at home, such as via a loop-mediated isothermal amplification (LAMP), reverse-transcription LAMP (RT-LAMP), microfluidic chip, or polymerase chain reaction (PCR) assay and upload the test results to the database for storage in his or her profile. Given recent developments in simple, cost effective assays, the individual may test himself or herself and upload the results in this manner on a daily or other frequent basis. For example, the results of such at-home assays may include a unique identifier specific to a given test run, such as a bar code, alphanumeric code, or other suitable identifier, that the individual scans with a camera on a personal electronic device. The unique identifier then may be authenticated by an algorithm in an application on the electronic device and sent to the database, thereby validating the test results in association with the individual.

In any such embodiments, uploaded negative test result(s) may provide the individual with a temporary health passport that lasts for a predetermined duration (e.g., a day) after which the individual must again test negative for the pathogen(s). Alternatively, uploaded test results indicating that the individual has tested positive for antibodies to one or more pathogens may provide the individual with a temporary or permanent health passport, depending upon the nature of the pathogen(s). The temporary or permanent health passport may be associated with the individual's profile so that when the camera 22 captures the individual's facial image and the processing circuitry 42 finds a match for the image of the individual's face in the database, the processing circuitry 42 may identify the individual as having a valid health passport and the entry system 10 will cause the digital door lock to unlock.

Data pertaining to the health status and status history of the individual stored in the individual's profile may be accessed by certain authorized users, particularly if the database is accessible remotely from the entry system 10. For example, where the entry system 10 controls access to a workplace and the individual is an employee of the workplace, human resources personnel may be authorized to obtain data pertaining to the individual's health status and status history from the database as desired. In this manner the health statuses of employees may be monitored, such as for indications that an infectious disease outbreak is occurring among employees. In some embodiments, the data associated with the health statuses of one or more employees over time may be fed to an artificial intelligence (AI) algorithm capable of learning which symptoms are likely to be indicative of a particular disease, which may be particularly advantageous for detecting whether an individual has one or more of any number of diseases that can be identified by the parameters detected by the entry system 10.

Next, the processing circuitry 42 determines whether or not to cause the communication circuitry 44 to transmit a signal to the digital door lock instructing the digital door lock to unlock based on the determined identity and the health status of the individual (58). In either case, the processing circuitry 42 optionally may cause the graphical user interface 20 to display a message to the individual indicating whether access has been granted, and if not, may display a reason why; e.g., “individual unauthorized/unknown,” “health status suggests presence of infectious disease,” or the like.

FIG. 5 is a flow diagram of another example technique for using the face-based door entry system 10 to regulate a digital door lock based on facial recognition of an individual and a reserved access time associated with the individual. For example, the entry system 10 may be used to regulate the number of guests present within a retail establishment at a given time, which may provide advantages such reducing virus transmission by reducing human proximity in the establishment. In all embodiments, the technique of FIG. 5 may be carried out in a semi-automated or fully-automated manner by the entry system 10 and optionally may provide contact-free, facial-recognition based payment for goods. The technique of FIG. 5 may be used in substantially any type of retail establishment.

According to the embodiment of FIG. 5, the processing circuitry 42 receives a signal from the graphical user interface 20 corresponding to an image of the face of the individual captured by the optical camera 22 when the individual is positioned in a sensing zone of the camera 22 (60). After receiving the signal corresponding to the image of the face of the individual captured by the optical camera 22, the processing circuitry 42 of determines the identity of the individual based on the image of the face (62). The processing circuitry 42 may determine the identity of the individual as discussed above with respect to FIG. 4; e.g., by comparing the image of the individual's face to a database of authorized entrants stored in memory 46 of the entry system 10 or by accessing a remote database to enable comparison of the image of the individual's face to images in the remote database. In either case, if the processing circuitry 42 finds a match for the image of the individual's face in the database, the processing circuitry 42 determines the identity of the individual as being the identity associated with the facial image in the database. If the processing circuitry 42 does not find a match for the image of the individual's face in the database, the processing circuitry may identify/designate the identity of the individual as “unknown,” “unauthorized,” or the like and the entry system 10 does not cause the digital door lock to unlock.

Next, if the processing circuitry 42 has determined the identity of the individual as being an identity associated with a facial image in the database, the processing circuitry 42 then determines whether the individual has a valid reservation to access the restricted area regulated by the digital door lock at the current time (64). For example, the processing circuitry 42 may access a user profile (e.g., a PopID profile) associated with the identity of the individual in the database, which may include data pertaining to reservation(s) that the individual has made to access a given area at a particular time. The processing circuitry 42 may search the individual's user profile to determine whether the individual has a valid reservation to access the area regulated by the digital door lock at the current time. In some examples, the area regulated by the digital door lock may be a retail establishment providing goods for a monetary fee.

Upon determining that the individual has a valid reservation to access the area regulated by the digital door lock at the current time, the processing circuitry 42 causes the communication circuitry to transmit a signal to the digital door lock instructing the digital door lock to unlock (66). Alternatively, if the processing circuitry 42 determines that the individual does not have a valid reservation to access the regulated area at the current time, the processing circuitry 42 does not cause the communication circuitry 44 to transmit a signal to the digital door lock instructing the digital door lock to unlock, thereby preventing the individual from accessing the regulated area at the current time. In either case, the processing circuitry 42 optionally may cause the graphical user interface 20 to display a message to the individual indicating whether access has been granted, and if not, may display a reason why; e.g., “individual unauthorized/unknown,” “reservation invalid/expired/not yet available,” or the like.

Optionally, a system for use in the technique of FIG. 5 may further include a temperature sensor configured to receive infrared radiation from the individual when the individual is positioned within a sensing zone of the temperature sensor (e.g., the temperature sensor 24). As described above with respect to the technique of FIG. 4, the processing circuitry 42 may be configured to receive a signal from the temperature sensor 24 corresponding to the body temperature of the individual and determine whether the body temperature of the individual exceeds a threshold value. If the processing circuitry 42 determines that the body temperature of the individual exceeds the threshold value, the processing circuitry 42 may override a determination to cause the communication circuitry 44 to transmit a signal instructing the digital door lock to unlock, even if the processing circuitry 42 has already determined that the individual 42 has a valid reservation to access the regulated area at the current time. Optionally, the processing circuitry 42 may cause data pertaining to a determination that the body temperature of the individual exceeds the threshold value to be stored in association with the individual's profile.

Optionally, a system for use in the technique of FIG. 5 may further include a scanner configured for placement within the retail establishment and configured to identify the type and quantity of goods transported by the individual past the scanner after the individual has finished shopping in the establishment, and a payment apparatus (not shown) configured for placement within the retail establishment. The payment apparatus may be substantially similar to the entry system 10, in that it may include a housing containing an optical camera, communication circuitry, and processing circuitry, which may be substantially similar in physical configuration to the camera 22, communication circuitry 44, and the processing circuitry 42 of the entry system 10. The processing circuitry of the payment apparatus may be configured to receive a signal corresponding to an image of the face of the individual captured by the optical camera when the individual is positioned in a sensing zone of the optical camera and determine an identity of the individual based on the image of the face. Simultaneously or subsequently, the processing circuitry of the payment apparatus may receive from the scanner a monetary value owed by the individual for the goods transported by the individual past the scanner. The processing circuitry of the payment apparatus then may communicate with a remote computing device, via the communication circuitry of the payment apparatus, to process payment by the individual for the monetary value owed by the individual.

In some such embodiments, the processing circuitry of the payment apparatus may be configured to communicate with the remote computing device to the process payment by transmitting, via the communication circuitry, the identity of the individual and the monetary value owed by the individual. The remote computing device may be configured to then charge the monetary value to a payment account, e.g., a credit card account, bank account, or other payment account, linked to the individual's profile. In this manner, the technique of FIG. 5 advantageously may enable truly a contact-free payment experience that does not require the individual to use, or even keep on his or her person, a physical payment medium or mobile device storing payment information.

FIG. 6 is a flow diagram of another example technique for using the face-based door entry system 10 in a face-based guest check-in system according to one or more embodiments. For example, the entry system 10 may be used to check-in guests at a restaurant, hotel, or other establishment where a guest may have a reservation to receive services or goods at a particular time and place (e.g., a table in a restaurant or a room in a hotel).

According to the embodiment of FIG. 6, the entry system 10 may perform facial recognition of an individual in substantially the same manner as described above with respect to the techniques of FIGS. 4 and 5. That is, the processing circuitry 42 receives a signal from the graphical user interface 20 corresponding to an image of the face of the individual captured by the optical camera 22 when the individual is positioned in a sensing zone of the camera 22 (70). After receiving the signal corresponding to the image of the face of the individual captured by the optical camera 22, processing circuitry 42 of determines the identity of the individual based on the image of the face (72), as discussed above with respect to steps (52) and (54) of FIG. 4 and steps (60) and (62) of FIG. 5. In the embodiment of FIG. 6, the facial recognition steps may take place inside the establishment; e.g., at a host's stand in a restaurant or front desk at a hotel, where the entry system 10 may be incorporated into a kiosk, stand, or any other suitable support apparatus configured to securely position the entry system at an appropriate height. Alternatively, the facial recognition steps (70) and (72) may take place outside the establishment with the entry system 10 positioned on an exterior wall of the establishment or in a kiosk. In this manner the entry system 10 provides semi-automated or fully-automated guest check-in that reduces or eliminates the need for such tasks to be performed by a human.

Next, if the processing circuitry 42 has determined the identity of the individual as being an identity associated with a facial image in the database, the processing circuitry 42 then determines whether the individual has a valid reservation to access reserved goods or services at the establishment at the current time (74). For example, the processing circuitry 42 may access a user profile (e.g., a PopID profile) associated with the identity of the individual in the database, which may include data pertaining to reservation(s) that the individual has made to access reserved goods or services at a particular time, such as a table at a restaurant or a room in a hotel. The processing circuitry 42 then may search data associated with the individual's user profile to determine whether the individual has a valid reservation at the current time.

Upon determining that the individual has a valid reservation to access the access reserved goods or services at the current time, the processing circuitry 42 causes the graphical user interface 20 to display instructions for the individual to access the reserved goods or services based on a determination that the individual has a valid reservation (76). For example, in a restaurant setting, the graphical user interface 20 may display a table number and/or table map indicating which table the individual should proceed to, optionally with any other relevant information. In a hotel, the graphical user interface 20 may display a room number and/or building map indicating which room the individual may proceed to, optionally with any other relevant information. In the example of a hotel the entry system 10 may be operatively connected to a system for dispensing room key cards upon determining that the individual has a valid reservation, or the hotel may be equipped with another entry system 10 at each room for use instead of a key card.

Alternatively, if the processing circuitry 42 determines that the individual does not have a valid reservation to access the goods or services at the current time, the processing circuitry 42 may cause the graphical user interface 20 to display a message to the individual indicating that no valid reservation is available and may display a reason why; e.g., “individual unauthorized/unknown,” “reservation invalid/expired/not yet available,” or the like.

Optionally, a system for use in the technique of FIG. 6 may further include a temperature sensor (e.g., the temperature sensor 24) for use substantially as discussed above with respect to FIGS. 4 and 5. Optionally, a system for use in the technique of FIG. 6 may further include a payment apparatus for use substantially as described above with respect to FIG. 5, enabling the individual to pay for goods and/or services received at the establishment by facial recognition. For example, in such embodiments, a user profile associated with the individual may track the monetary value of goods and/or services received by the individual at the establishment so that the individual can make payments using the payment apparatus one or more times during his or her visit; e.g., upon leaving the restaurant or checking out of the hotel.

The description of the invention and its applications as set forth herein is illustrative and is not intended to limit the scope of the invention. Features of various embodiments may be combined with other embodiments within the contemplation of this invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A method for confirming that a biological sample provided by an individual and sent to a testing facility was obtained from the individual, comprising:
obtaining a sample collection unit containing the biological sample and a video of the individual providing the biological sample, wherein the individual provides the biological sample by:
recording a video of himself or herself:
opening the sample collection unit;
depositing the biological sample into the sample collection unit; and
closing the sample collection unit;
analyzing the biological sample for one or more of at least one pathogen and at least one antibody to a pathogen;
analyzing the video to ensure that the individual in the video provided the sample; and
performing facial recognition on the video to correlate the sample collection unit and the biological sample to the individual.

2. The method of claim 1, wherein the sample collection unit comprises a visual indicator indicating when it has been opened for the first time.

3. The method of claim 1, wherein the sample collection unit comprises a unique visual indicator enabling correlation of the biological sample to the individual.

4. The method of claim 1, wherein the sample collection unit comprises a visual indicator indicating when it has been closed.

5. The method of claim 1, wherein the sample collection unit comprises a locking mechanism configured to prevent re-opening of the sample collection unit without damaging the sample collection unit or creating a visual indicator.

6. The method of claim 1, wherein the biological sample is a saliva sample.

7. The method of claim 6, wherein the sample collection unit comprises a visual indicator indicating the presence of saliva.

8. The method of claim 1, wherein the individual recording the video of himself or herself further comprises the individual providing video of a photo ID of the individual.

9. The method of claim 8, further comprising correlating the identity of the individual to the provided video of the photo ID of the individual.

10. The method of claim 1, further comprising uploading the results of the analyzing the biological sample for the one or more of the at least one pathogen and the at least one antibody to the pathogen to a database in association with the identity of the individual for use at a facial recognition enabled entry system to provide access to a restricted area.
